(19) United States
(12) Patent Application Publication
(10) Pub. No.: US 2011/0276728 A1
(43) Pub. Date: Nov. 10, 2011

(54) METHOD AND APPARATUS FOR STORAGE I/O PATH CONFIGURATION

(75) Inventor: Toshio OTANI, Sunnyvale, CA (US)

(73) Assignee: HITACHI, LTD., Tokyo (JP)

(21) Appl. No.: 12/775,009

(22) Filed: May 6, 2010

(51) Int. Cl. G06F 3/00

(52) U.S. Cl. 710/37; 710/38

(57) ABSTRACT

An aspect of the invention is directed to a method for storage I/O (input/output) path configuration in a system that includes a storage system connected via a network to a plurality of nodes. The method comprises receiving an I/O access to one or more storage volumes in the storage system from one of the nodes; if the I/O access is an initial I/O access to any of the storage volumes in the storage system from any of the nodes in the system, allowing the initial I/O access from the one node and prohibiting I/O access to the storage volumes in the storage system by other nodes in the system; and if the I/O access is not an initial I/O access to any of the storage volumes in the storage system from any of the nodes in the system, allowing the I/O access only if the I/O access is from the one node which made the initial I/O access and rejecting the I/O access for other nodes in the system.

### BACKGROUND OF THE INVENTION

The present invention relates generally to storage systems and, more particularly, to methods and apparatuses for storage I/O (input/output) path configuration and to reduce the workforce for configuring storage I/O path.

This invention is related to storage area network (SAN) using Fibre Channel (FC), Fibre Channel over Ethernet (FCoE), and iSCSI. It is also related to network attached storage (NAS) using NFS (Network File System) and CIFS (Common Internet File System). Configuring storage I/O path by using SAN or NAS is a burdensome task for many storage administrators. More specifically, the storage administrator needs to set up access control for the storage I/O path such as LUN Masking, Zoning, VLAN, IP Access Control, and “Hosts.allow” because of security concerns. Many storage nodes require significant workload for storage administration. Securing an SAN I/O path will be done by LUN Masking, SAN Zoning, and VLAN. Securing an NAS I/O path will be done by host based access control, IP address based access control, and so on.

### BRIEF SUMMARY OF THE INVENTION

Exemplary embodiments of the invention provide methods and apparatuses for storage I/O path configuration and to reduce the workforce for configuring storage I/O path. The first storage node creates one or more volumes for other storage nodes. At first, the volumes in the first storage node can be accessed from every other storage node which has joined the same domain. The first storage node sets a first volume access control to allow other storage nodes within the same domain to discover the above volumes created by the first storage node. Once a certain storage node tries to log in to a certain volume, the first storage node allows that certain storage node to access that certain volume. At the same time, the first storage node sets a second volume access control to allow only that certain storage node to access that certain volume. When that certain storage node logs out from that certain volume, the first storage node disables the second volume access control.

An aspect of the present invention is directed to a method for storage I/O (input/output) path configuration in a system that includes a storage system connected via a network to a plurality of nodes. The method comprises receiving an I/O access to one or more storage volumes in the storage system from one of the nodes; if the I/O access is an initial I/O access to any of the storage volumes in the storage system from any of the nodes in the system, allowing the initial I/O access from the one node and prohibiting I/O access to the storage volumes in the storage system by other nodes in the system; and if the I/O access is not an initial I/O access to any of the storage volumes in the storage system from any of the nodes in the system, allowing the I/O access only if the I/O access is from the one node which made the initial I/O access and rejecting the I/O access for other nodes in the system.

In some embodiments, the method further comprises allowing the initial I/O access to the storage volumes in the storage system by a preset group of nodes in the system. The preset group of nodes is a subset of the plurality of nodes in the system, and other nodes in the system not in the preset group are not allowed the initial I/O access to the storage volumes in the storage system. Access control by the preset group of nodes is achieved by any of LUN security/LUN masking, FC switch zoning, MAC address based access control, IP address based access control, TCP port addressed based access control, and iSNS database (iSCSI specific).

In specific embodiments, receiving an I/O access comprises receiving a login request from one of the nodes in the system. The login request is allowed if the I/O access is an initial I/O access to any of the storage volumes in the storage system from any of the nodes in the system and if the one node making the login request is in the preset group of nodes. The login request is rejected if the I/O access is not an initial I/O access to any of the storage volumes in the storage system from any of the nodes in the system or if the one node making the login request is not in the preset group of nodes. The login request from the one node is allowed, and the method further comprises receiving by the storage system a logout request from the one node; completing a logout process in response to the logout request from the one node; formatting the storage volumes in the storage system; and allowing a new initial I/O access to the formatted storage volumes in the storage system from a node that is in the preset group of nodes. The method further comprises creating one or more virtual ports in the storage system; assigning a virtual port to each of the storage volumes in the storage system; and activating the storage volumes and the one or more virtual ports; wherein allowing a new initial I/O access comprises activating the formatted storage volumes and the one or more virtual ports.

Another aspect of the invention is directed to a storage system in a system for storage I/O (input/output) path configuration which includes a plurality of nodes connected via a network to the storage system. The storage system comprises a processor; a memory; a plurality of storage volumes; and an I/O control which is configured, in response to an I/O access to one or more storage volumes in the storage system from one of the nodes, to, if the I/O access is an initial I/O access to any of the storage volumes in the storage system from any of the nodes in the system, allow the initial I/O access from the one node and prohibiting I/O access to the storage volumes in the storage system by other nodes in the system; and if the I/O access is not an initial I/O access to any of the storage volumes in the storage system from any of the nodes in the system, allow the I/O access only if the I/O access is from the one node which made the initial I/O access and rejecting the I/O access for other nodes in the system.

In some embodiments, the I/O control is configured to allow the initial I/O access to the storage volumes in the storage system by a preset group of nodes in the system. The I/O control allows the login request and the storage system subsequently receives a logout request from the one node; the storage system includes a logical volume control; the I/O control is configured to complete a logout process in response to the logout request from the one node; the logical volume control is configured to format the storage volumes in the storage system after the logout process; and the I/O control is configured to allow a new initial I/O access to the formatted storage volumes in the storage system from a node that is in the preset group of nodes. The logical volume control is configured to create one or more virtual ports in the storage system and assign a virtual port to each of the storage volumes in the storage system, and the I/O control is configured to activate the storage volumes and the one or more virtual ports; and the I/O control is configured to allow a new initial I/O access by activating the formatted storage volumes and the one or more virtual ports.

In specific embodiments, the I/O control is configured to process storage I/O protocol selected from the group consisting of FC (Fibre Channel), iSCSI (Internet Small Computer System Interface), FCoE (Fibre Channel over Ethernet), NFS (Network File System), and CIFS (Common Internet File System). The I/O control processes FC/FCoE storage I/O protocol; and the logical volume control creates the one or more virtual ports by NPIV (N_Port ID Virtualization). The nodes are storage systems.

Another aspect of this invention is directed to a computer-readable storage medium storing a plurality of instructions for controlling a data processor to manage storage I/O (input/output) path configuration in a system that includes a storage system connected via a network to a plurality of nodes. The plurality of instructions comprise instructions that cause the data processor, if the I/O access is an initial I/O access to any of the storage volumes in the storage system from any of the nodes in the system, to allow the initial I/O access from the one node and prohibiting I/O access to the storage volumes in the storage system by other nodes in the system; and instructions that cause the data processor, if the I/O access is not an initial I/O access to any of the storage volumes in the storage system from any of the nodes in the system, to allow the I/O access only if the I/O access is from the one node which made the initial I/O access and rejecting the I/O access for other nodes in the system.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration of an information system in which the method and apparatus of the invention may be applied.

FIG. 2 shows an example of the software configuration of the upper node in the information system of FIG. 1.

FIG. 3 shows an example of the software configuration of the lower node in the information system of FIG. 1.

FIG. 4 shows an example of the software configuration of the management node in the information system of FIG. 1.

FIG. 5 shows an example of the logical structure of dynamic storage I/O path allocation for the information system of FIG. 1.

FIG. 6a shows an example of access control database for the first volume access control in the information system of FIG. 1.

FIG. 6b shows an example of access control database for the second volume access control in the information system of FIG. 1.

FIG. 7 shows an example of storage domain database illustrating nodes in domains in the information system of FIG. 1.

FIG. 8a shows an example of a flow diagram illustrating the logical volume control of the lower node.

FIGS. 8b and 8c show an example of a flow diagram for dynamic volume allocation illustrating dynamic storage I/O path allocation by the IO control of the lower node.

FIG. 9 illustrates an example of a hardware configuration of an information system for a Fibre Channel network (FC/FCoE).

FIG. 10 shows an example of the software configuration of the upper node in the information system of FIG. 9.

FIG. 11 shows an example of the software configuration of the lower node in the information system of FIG. 9.

FIG. 12 shows an example of the logical structure of dynamic storage I/O path allocation for the information system of FIG. 9.

FIG. 13a shows an example of access control database for the first volume access control in the information system of FIG. 9.

FIG. 13b shows an example of access control database for the second volume access control in the information system of FIG. 9.

FIG. 14 shows an example of storage domain database illustrating nodes in domains in the information system of FIG. 9.

FIG. 15 illustrates an example of a hardware configuration of an information system for iSCSI with an IP/Ethernet network.

FIG. 16 shows an example of the software configuration of the upper node in the information system of FIG. 15.

FIG. 17 shows an example of the software configuration of the lower node in the information system of FIG. 15.

FIG. 18 shows an example of the logical structure of dynamic storage I/O path allocation for the information system of FIG. 15.

FIG. 19a shows an example of access control database for the first volume access control in the information system of FIG. 15.

FIG. 19b shows an example of access control database for the second volume access control in the information system of FIG. 15.

FIG. 20 shows an example of storage domain database illustrating nodes in domains in the information system of FIG. 15.

FIG. 21 illustrates an example of a hardware configuration of an information system for NFS/CIFS with an IP/Ethernet network.

FIG. 22 shows an example of the software configuration of the upper node in the information system of FIG. 21.

FIG. 23 shows an example of the software configuration of the lower node in the information system of FIG. 21.

FIG. 24 shows an example of the logical structure of dynamic storage I/O path allocation for the information system of FIG. 21.

FIG. 25a shows an example of access control database for the first volume access control in the information system of FIG. 21.

FIG. 25b shows an example of access control database for the second volume access control in the information system of FIG. 21.

FIG. 26 shows an example of storage domain database illustrating nodes in domains in the information system of FIG. 21.

FIG. 27 illustrates an example of a hardware configuration of an information system for a multi-protocol environment.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for storage I/O path configuration and to reduce the workforce for configuring storage I/O path.

1. Basic Mechanism

System Configuration

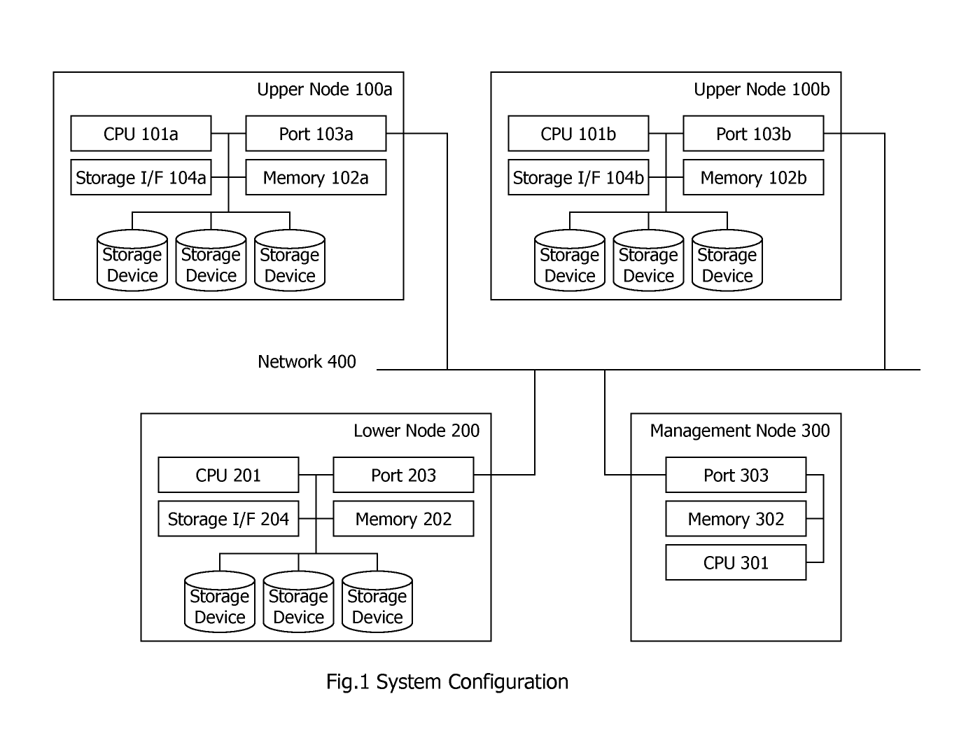

FIG. 1 illustrates an example of a hardware configuration of an information system in which the method and apparatus of the invention may be applied. The system includes one or more upper nodes 100 (100a, 100b), a lower node 200, and a management node 300 connected via a network 400.

The upper node 100 has a CPU 101, a memory 102, a networking port 103 to connect to the network 400, and a storage I/F (interface) 104 (such as SAS (Serial Attached SCSI)) to connect to storage devices such as flash memory and hard disk drive devices. The lower node 200 has a CPU 201, a memory 202, a networking port 203 to connect to the network 400, and a storage I/F 204 to connect to storage devices such as flash memory and hard disk drive devices. The management node 300 has a CPU 301, a memory 302, and a networking port 303 to connect to the network 400. The network 400 may be FC-SAN, IP-SAN, or Ethernet-SAN such as FCoE. The network 400 may also be IP/Ethernet to transfer NFS/CIFS protocol packets.

In general, the upper nodes 100 may include a variety of devices such as storage systems, host computers, virtual machines, and the like. In specific embodiments, the upper nodes 100 as well as the lower node 200 are storage systems each having a processor, a memory, and storage devices, the storage systems connected via a network to form a network configuration of a storage array.

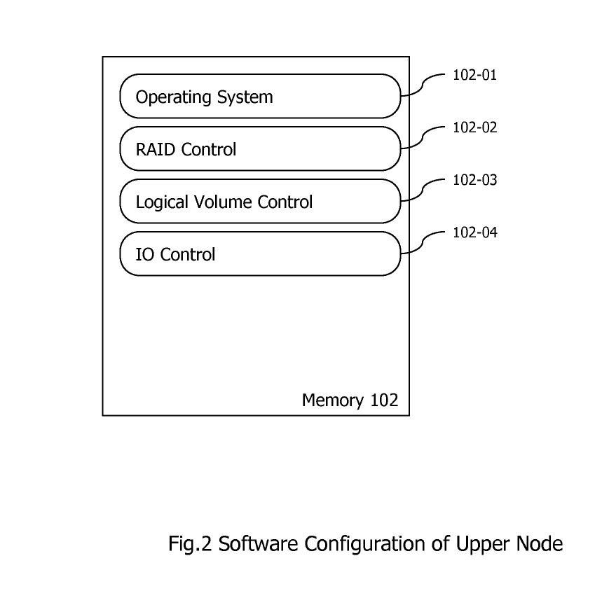

FIG. 2 shows an example of the software configuration of the upper node 100. The memory 102 of the upper node 100 includes an operating system 102-01. A RAID control 102-02 creates RAID (Redundant Arrays of Inexpensive Disks) configuration by using storage devices behind the storage I/F 104. A logical volume control 102-03 processes SCSI layer read/write command, volume access control, and so on. An IO control 102-04 processes storage IO protocol such as FC (Fibre Channel), iSCSI, FCoE (Fibre Channel over Ethernet), NFS, CIFS, and so on.

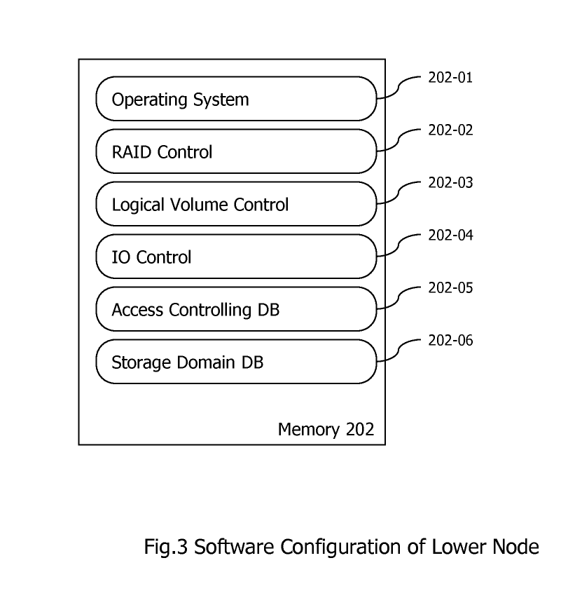

FIG. 3 shows the software configuration of the lower node 200. The memory 202 of the lower node 200 includes an operating system 202-01. A RAID control 202-02 creates RAID configuration by using storage devices behind the storage I/F 204. A logical volume control 202-03 processes SCSI layer read/write command, volume access control, and so on. An IO control 202-04 processes storage IO protocol such as FC, iSCSI, FCoE, NFS, CIFS, and so on. An access control DB 202-05 and a storage domain DB 202-06 store databases for volume access controlling.

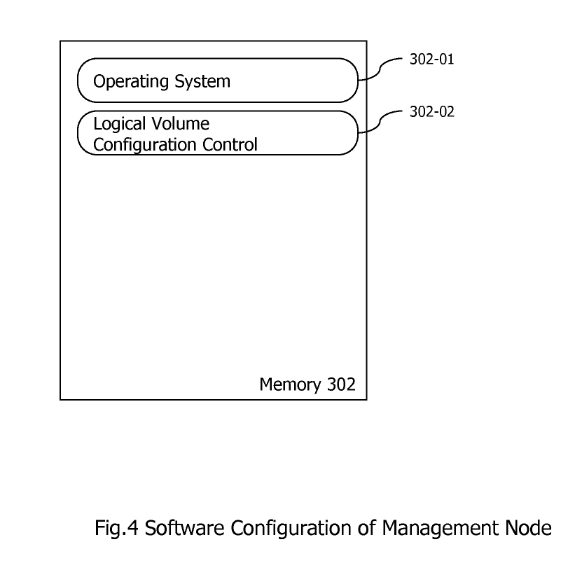

FIG. 4 shows the software configuration of the management node 300. The memory 302 of the management node 300 includes an operating system 302-01. A logical volume configuration control 302-02 allows the storage administrator to set up configurations in the upper and lower storage nodes.

Dynamic Storage I/O Path Allocation

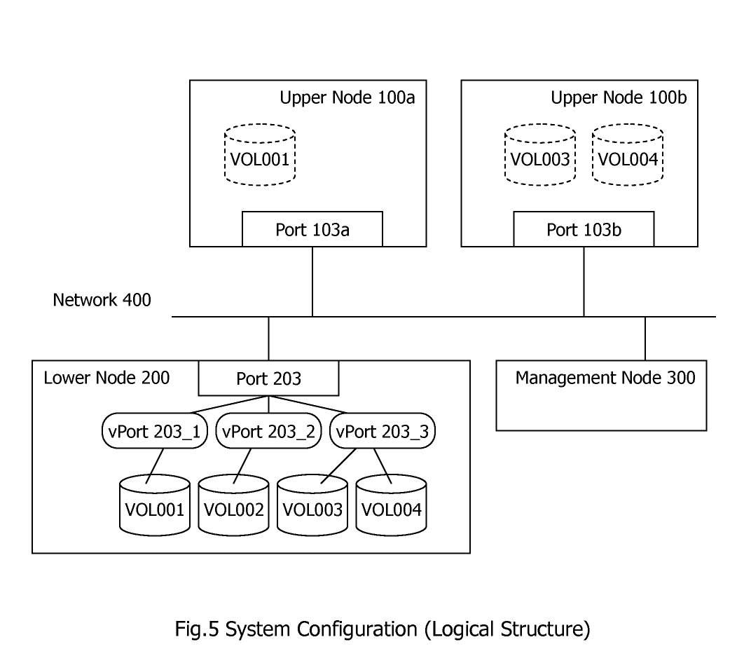

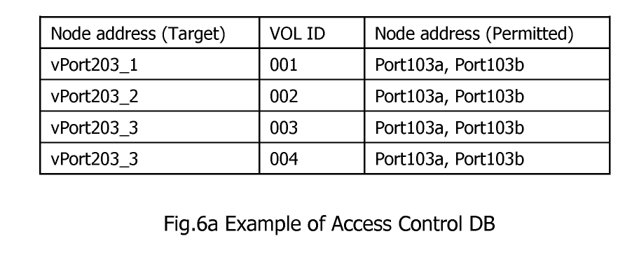

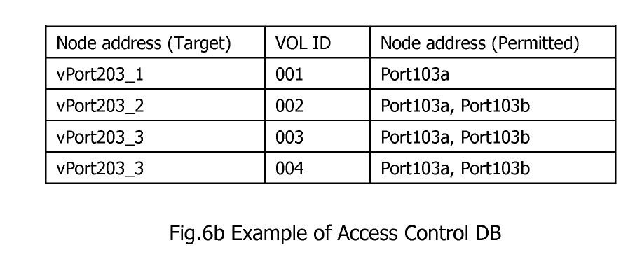

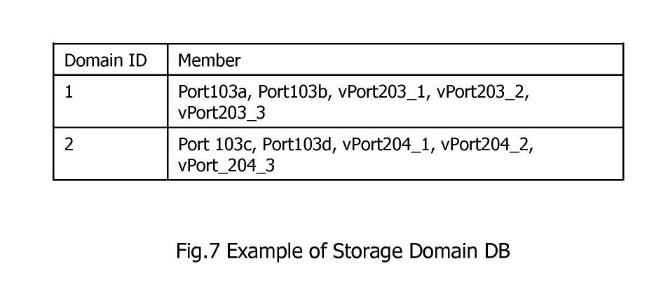

FIG. 5 shows the logical structure of dynamic storage I/O path allocation for the information system of FIG. 1. The lower node 200 provides volumes (volumes 001-004) to the upper nodes 100a and 100b (via virtual ports or vPorts 203_1, 203_2, 203_3). At first, volumes 001-004 can be accessed from both upper nodes 100a and 100b because the lower node 200 and upper nodes 100a and 100b join the same domain (see FIG. 7). The lower node 200 sets a first volume access control to allow the upper nodes 100a and 100b to discover volumes 001-004 (see FIG. 6a). Once the first upper node 100a tries to log in to volume 001, the lower storage node 200 allows the first upper storage node 100a to access volume 001. At the same time, the lower storage node 200 sets a second volume access control to allow only the first upper storage node 100a to access volume 001 (see FIG. 6b). Other storage nodes cannot discover and access volume 001 anymore even if they belong to the same domain. When the first upper storage node 100a logs out from volume 001, the lower storage node 200 disables the second volume access control for volume 001.

FIG. 6a shows an example of access control database for the first volume access control as discussed above. FIG. 6b shows an example of access control database for the second volume access control as discussed above. FIG. 7 shows an example of storage domain database illustrating nodes in domains as discussed above.

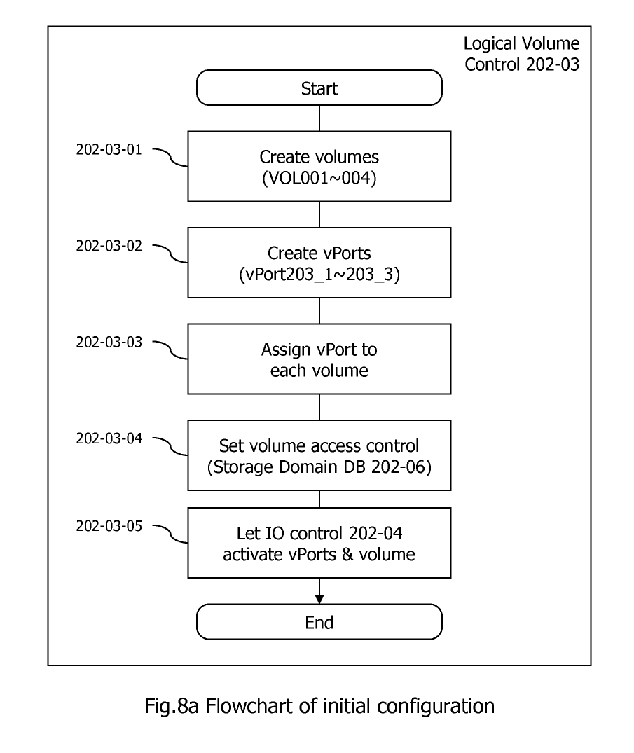

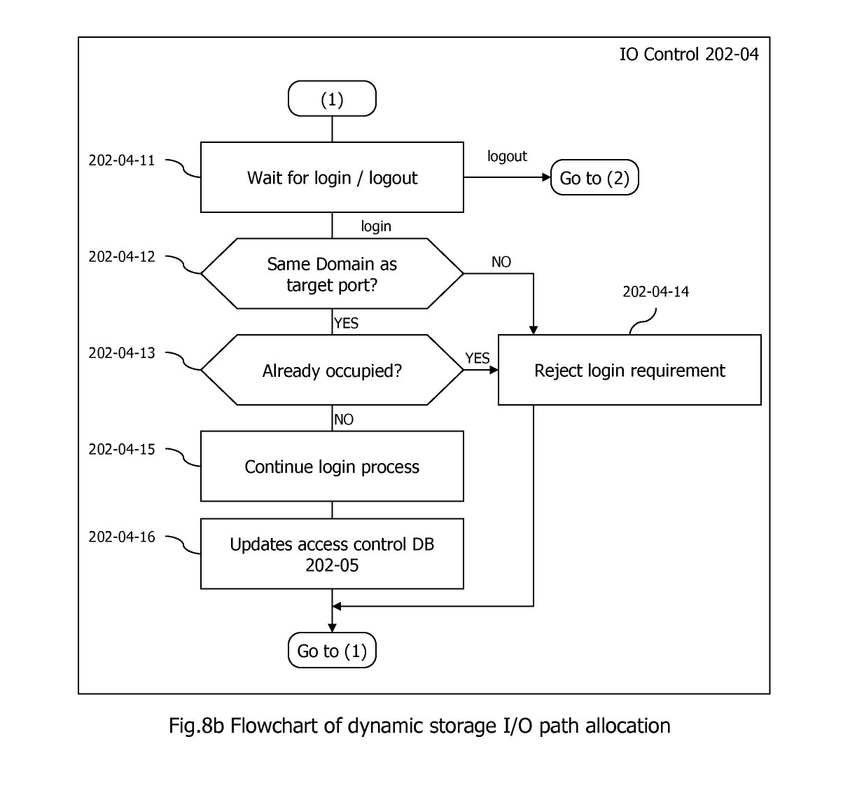

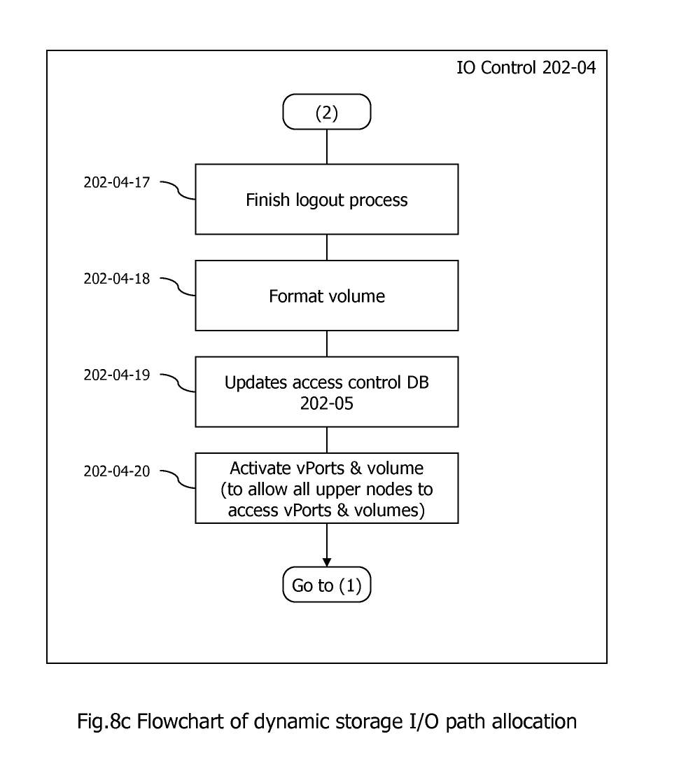

FIG. 8a shows an example of a flow diagram illustrating the logical volume control 202-03 of the lower node 200. It illustrates initial configuration which includes volume creation and setting up the first volume access control. In step 202-03-01, the program creates volumes (VOL001-004). The program creates vPorts (vPort203_1-203_3) in step 202-03-02 and assigns a vPort to each volume in step 202-03-03. In step 202-03-04, the program sets the first volume access control involving storage domain database 202-06. In step 202-03-05, the program lets the IO control 202-04 activate the vPorts and volumes.

FIGS. 8b and 8c show an example of a flow diagram for dynamic volume allocation illustrating dynamic storage I/O path allocation by the IO control 202-04 of the lower node 200. In step 202-04-11, the program waits for login or logout by a node. For logout, the program proceeds to step 202-04-17 of FIG. 8c. For login, the program proceeds to step 202-04-12 of FIG. 8b to determine whether the port of the login node is in the same domain as the target port. If no, the program rejects the login requirement in step 202-04-14. If yes, the program determines whether the target port is already occupied in step 202-04-13. If yes, the program rejects the login requirement in step 202-04-14. If no, the program continues the login process in step 202-04-15 and updates the access control database 202-05 in step 202-04-16, and returns to step 202-04-11.

In FIG. 8c, the program finishes the logout process in step 202-04-17 and formats the volume in step 202-04-18. In step 202-04-19, the program updates the access control database 202-05. In step 202-04-20, the program activates vPorts and volumes to allow all upper nodes 100 to access vPorts and volumes.

2. FC/FCoE

System Configuration

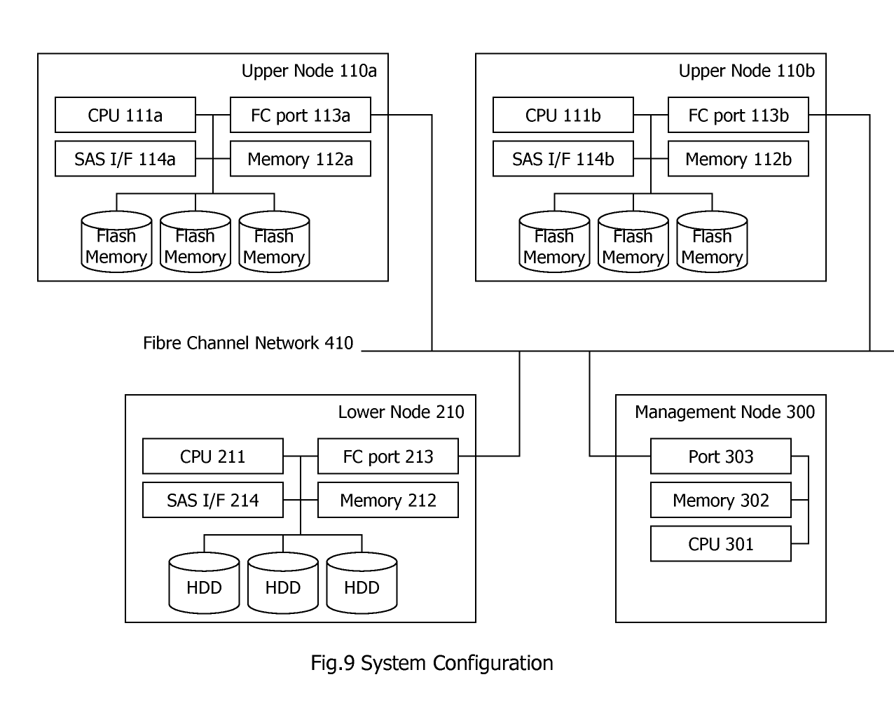

FIG. 9 illustrates an example of a hardware configuration of an information system for a Fibre Channel network (FC/FCoE). The system includes one or more upper nodes 110 (110a, 110b), a lower node 210, and a management node 300 connected via a Fibre Channel network 410.

The upper node 110 has a CPU 111, a memory 112, a networking port 113 to connect to the network 410, and a storage I/F 114 (such as SAS (Serial Attached SCSI)) to connect to storage devices such as flash memory and hard disk drive devices. The lower node 210 has a CPU 211, a memory 212, a networking port 213 to connect to the network 410, and a storage I/F 214 (such as SAS (Serial Attached SCSI)) to connect to storage devices such as flash memory and hard disk drive devices.

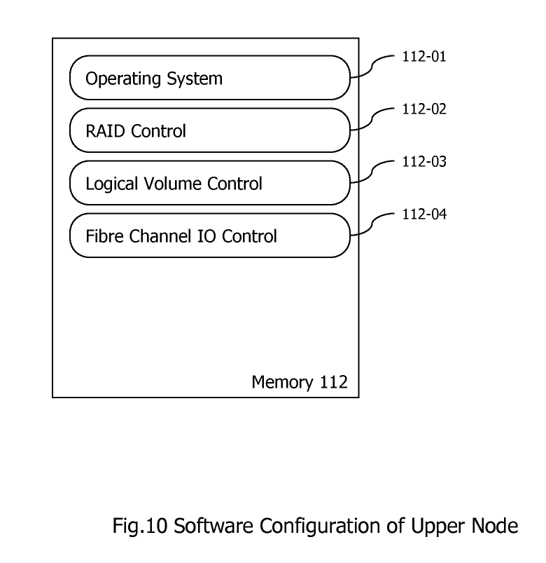

FIG. 10 shows the software configuration of the upper node 110 in the information system of FIG. 9. The memory 112 of the upper node 110 includes an operating system 112-01. A RAID control 112-02 creates RAID configuration by using storage devices behind the storage I/F 114. A logical volume control 112-03 processes SCSI layer read/write command, volume access control, and so on. An IO control 112-04 processes Fibre Channel Protocol as storage IO protocol.

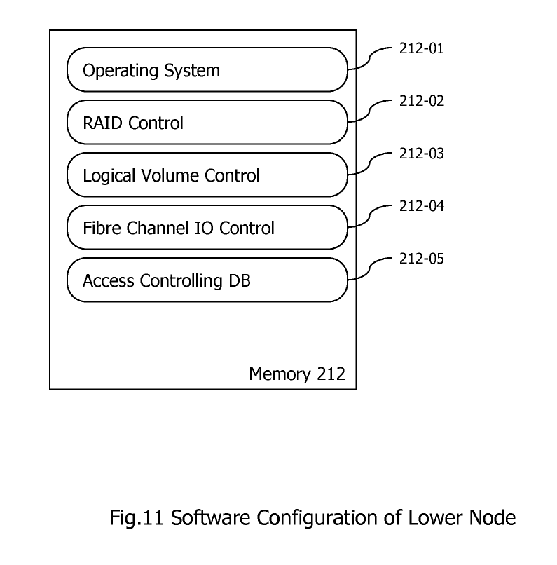

FIG. 11 shows the software configuration of the lower node 210 in the information system of FIG. 9. The memory 212 of the lower node 210 includes an operating system 212-01. A RAID control 212-02 creates RAID configuration by using storage devices behind the storage I/F 214. A logical volume control 212-03 processes SCSI layer read/write command, volume access control, and so on. An IO control 212-04 processes Fibre Channel Protocol as storage IO protocol. An access control DB 212-05 and a storage domain DB 212-06 store databases for volume access controlling.

Dynamic Storage I/O Path Allocation

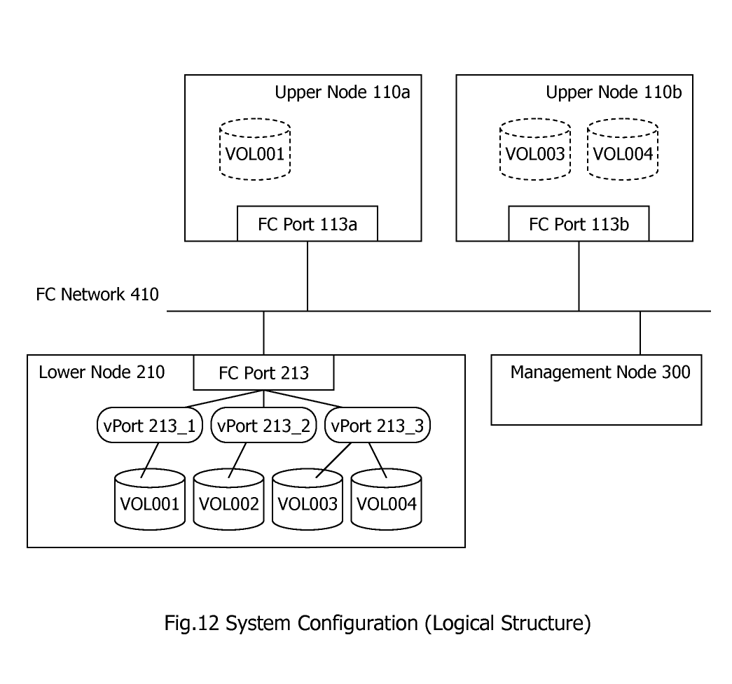

FIG. 12 shows an example of the logical structure of dynamic storage I/O path allocation for the information system of FIG. 9. The lower node 210 provides volumes (VOL001-004) to the upper nodes 110a and 110b. In this case, the lower node 210 creates one or more virtual ports on the physical FC port 213. Each virtual port is associated with one or more volumes (for instance, virtual port vPort 213_1 is associated with volume 001). Creating the virtual ports can be done by using NPIV (N_Port ID Virtualization) technology. For instance, the virtual port vPort 213_1 has a dedicated virtual address such as “00:AB:CD:02:13:01.” The lower node 210 executes each virtual port login process to the Fibre Channel Fabric by using the FLOGI method. It allows every other node within the same zoning to find virtual ports and volumes that are associated with the virtual ports.

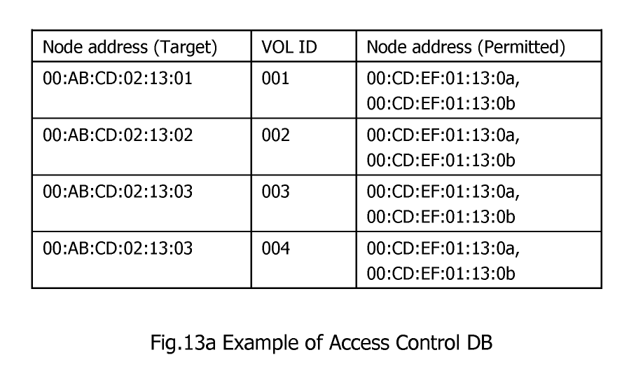

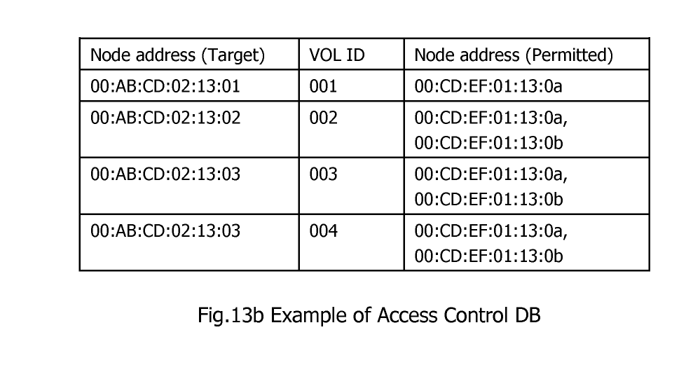

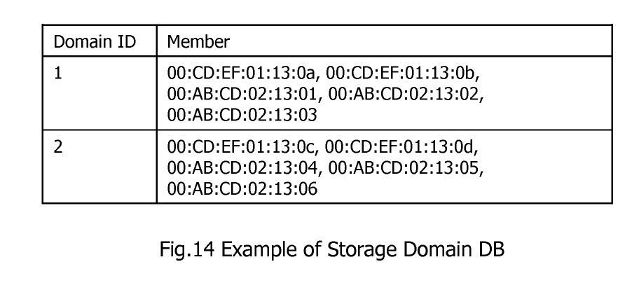

At first, volumes 001-004 can be accessed from both upper nodes 110a and 110b because the lower node 210 and the upper nodes 110a and 110b join the same domain (see FIG. 14). In this case, the domain equals “Fibre Channel Zoning.” The lower node 210 sets a first volume access control to allow the upper nodes 110a and 110b to discover volumes 001-004 (see FIG. 13a). Access control can be done by LUN Security/LUN Masking and FC switch zoning technologies. Other examples of dynamic access control techniques include MAC address based access control, IP address based access control, TCP port addressed based access control, and iSNS database (iSCSI specific).

Once the first upper node 110a tries to log in to volume 001, the lower storage node 210 allows the first upper storage node 110a to access volume 001. At the same time, the lower storage node 210 sets a second volume access control to allow only the first upper storage node 110a to access volume 001 (see FIG. 13b). Other storage nodes cannot discover and access volume 001 anymore even if they belong to the same domain. When the first upper storage node 110a logs out from volume 001, the lower storage node 210 disables the second volume access control for volume 001.

FIG. 13a shows an example of access control database for the first volume access control as discussed above. FIG. 13b shows an example of access control database for the second volume access control as discussed above. FIG. 14 shows an example of storage domain database illustrating nodes in domains as discussed above.

This Fibre Channel network configuration also supports FCoE (Fibre Channel over Ethernet). In that case, the upper nodes 110 and lower node 210 have Ethernet ports to process FCoE protocol as storage IO.

3. iSCSI

System Configuration

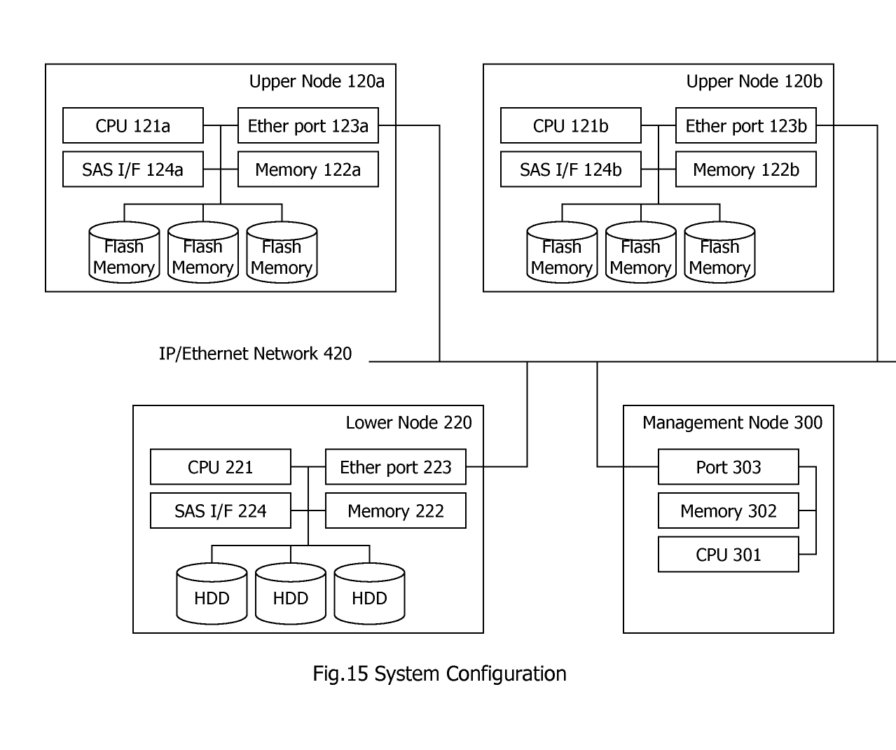

FIG. 15 illustrates an example of a hardware configuration of an information system for iSCSI with an IP/Ethernet network. The information system has one or more upper nodes 120 (120a, 120b), a lower node 220, and a management node 300 connected via an IP/Ethernet network 420.

The upper node 120 has a CPU 121, a memory 122, a networking port 123 to connect to the network 420, and a storage I/F 124 (such as SAS (Serial Attached SCSI)) to connect to storage devices such as flash memory and hard disk drive devices. The lower node 220 has a CPU 221, a memory 222, a networking port 223 to connect to the network 420, and a storage I/F 224 (such as SAS (Serial Attached SCSI)) to connect to storage devices such as flash memory and hard disk drive devices.

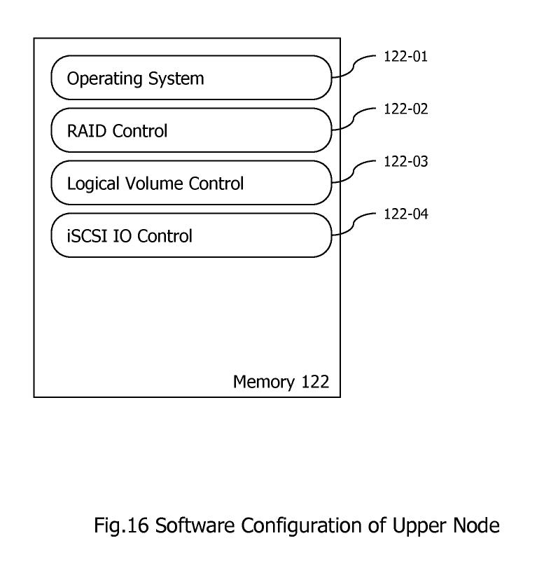

FIG. 16 shows the software configuration of upper node 120. The memory 122 of the upper node 120 has an operating system 122-01. A RAID control 122-02 creates RAID configuration by using storage devices behind the storage I/F 124. A logical volume control 122-03 processes SCSI layer read/write command, volume access control, and so on. An IO control 122-04 processes iSCSI (Internet SCSI) as storage IO protocol.

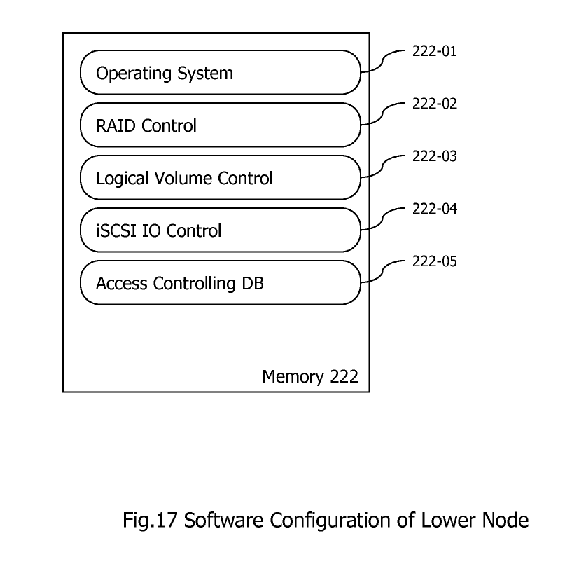

FIG. 17 shows the software configuration of lower node 220. The memory 222 of the lower node 220 has an operating system 222-01. A RAID control 222-02 creates RAID configuration by using storage devices behind the storage I/F 224. A logical volume control 222-03 processes SCSI layer read/write command, volume access control, and so on. An IO control 222-04 processes iSCSI as storage IO protocol. An access control DB 222-05 and a storage domain DB 222-06 store databases for volume access controlling.

Dynamic Storage I/O Path Allocation

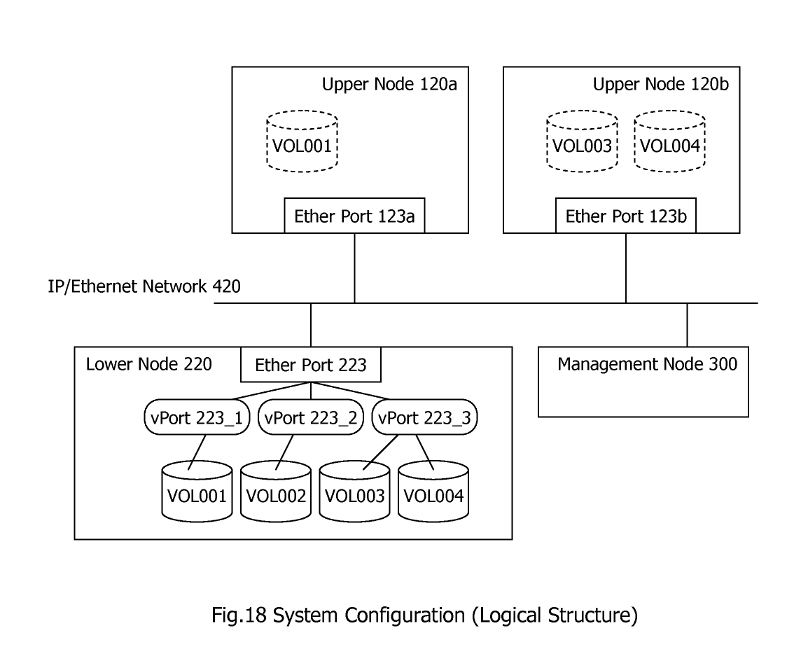

FIG. 18 shows an example of the logical structure of dynamic storage I/O path allocation for the information system of FIG. 15. The lower node 220 provides volumes (VOL001-004) to the upper nodes 120a and 120b. In this case, the lower node 220 creates one or more virtual ports on the physical Ethernet port 223. Each virtual port is associated with one or more volumes (for instance, virtual port vPort 223_1 is associated with volume 001). Each virtual port has one dedicated virtual address such as IP address, different TCP port (for instance, virtual port vPort 223_1 has a dedicated virtual address “1.1.22.31”). When the upper node 120a and/or upper node 120b issue a “discovery message” to the lower node 220 (discovery message is the one of iSCSI commands to discover which address can be used as an iSCSI target), the lower node 220 discloses its virtual port address that will be available to connect.

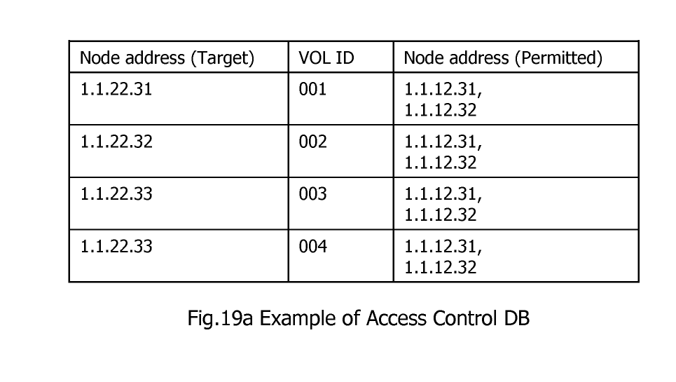

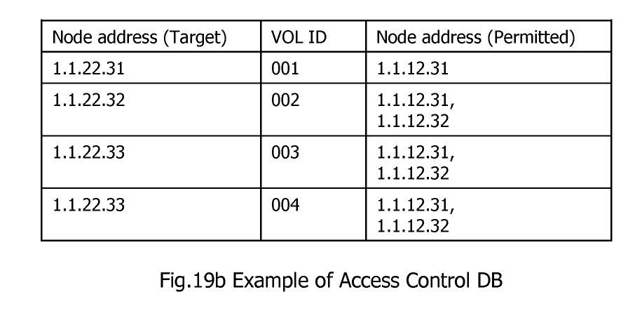

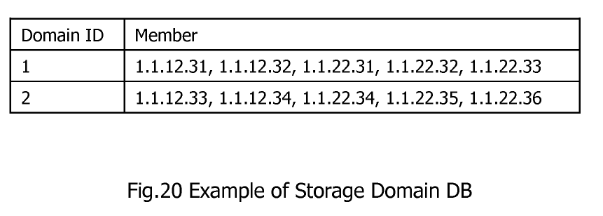

At first, volumes 001-004 can be accessed from both upper nodes 120a and 120b because the lower node 220 and the upper nodes 120a and 120b join the same domain (see FIG. 20). In this case, the domain can be expressed by “VLAN: Virtual LAN.” The lower node 220 sets a first volume access control to allow the upper nodes 120a and 120b to discover volumes 001-004 (see FIG. 19a). Access control can be done by LUN Masking and VLAN technologies.

Once the first upper node 120a tries to log in to volume 001, the lower storage node 220 allows the first upper storage node 120a to access volume 001. At the same time, the lower storage node 220 sets a second volume access control to allow only the first upper storage node 120a to access volume 001 (see FIG. 19b). Other storage nodes cannot discover and access volume 001 anymore even if they belong to the same domain. When the first upper storage node 120a logs out from volume 001, the lower storage node 220 disables the second volume access control for volume 001.

FIG. 19a shows an example of access control database for the first volume access control as discussed above. FIG. 19b shows an example of access control database for the second volume access control as discussed above. FIG. 20 shows an example of storage domain database illustrating nodes in domains as discussed above.

4. NFS/CIFS

System Configuration

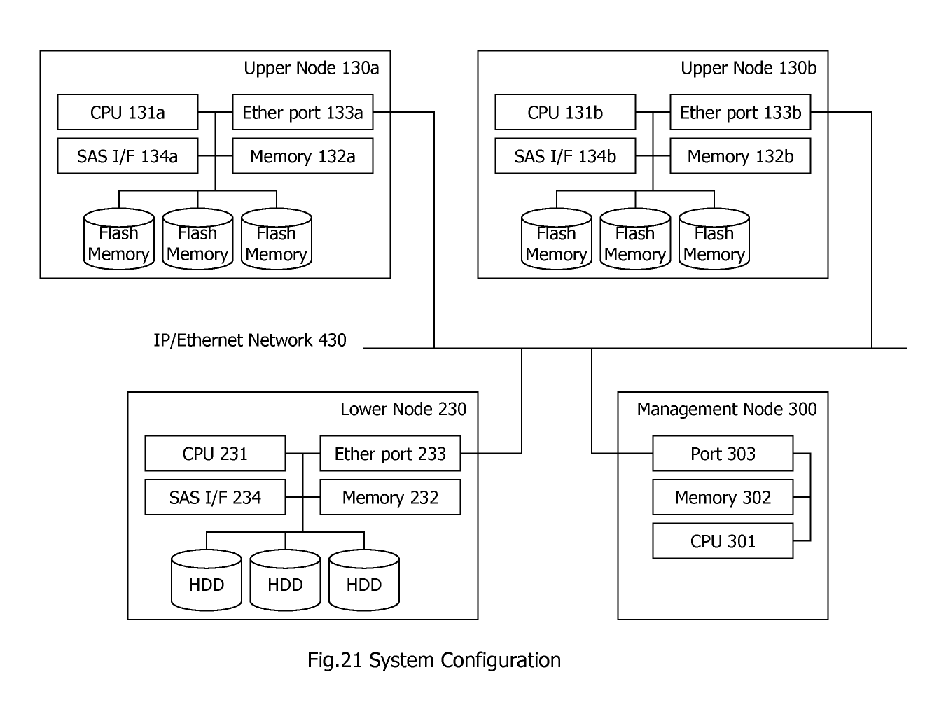

FIG. 21 illustrates an example of a hardware configuration of an information system for NFS/CIFS with an IP/Ethernet network. The information system has one or more upper nodes 130, a lower node 230, and a management node 300 connected via an IP/Ethernet network 430.

The upper node 130 has a CPU 131, a memory 132, a networking port 133 to connect to the network 430, and a storage I/F 134 (such as SAS (Serial Attached SCSI)) to connect to storage devices such as flash memory and hard disk drive devices. The lower node 230 has a CPU 231, a memory 232, a networking port 233 to connect to the network 430, and a storage I/F 234 (such as SAS (Serial Attached SCSI)) to connect to storage devices such as flash memory and hard disk drive devices.

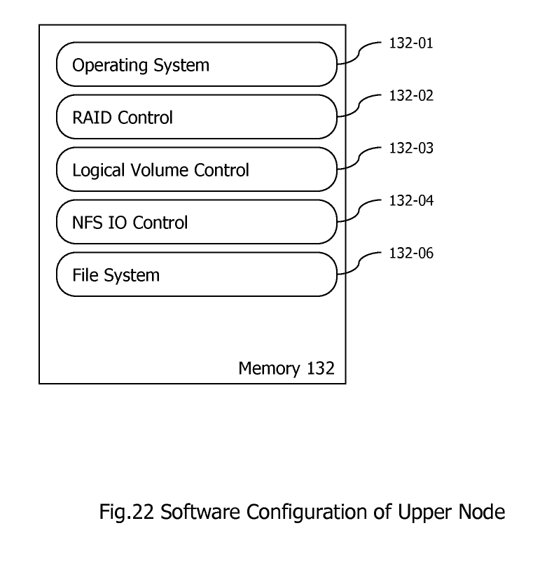

FIG. 22 shows the software configuration of upper node 130. The memory 132 of the upper node 130 has an operating system 132-01. A RAID control 132-02 creates RAID configuration by using storage devices behind the storage I/F 134. A logical volume control 132-03 processes SCSI layer read/write command, volume access control, and so on. An IO control 132-04 processes NFS (Network File System) as storage IO protocol.

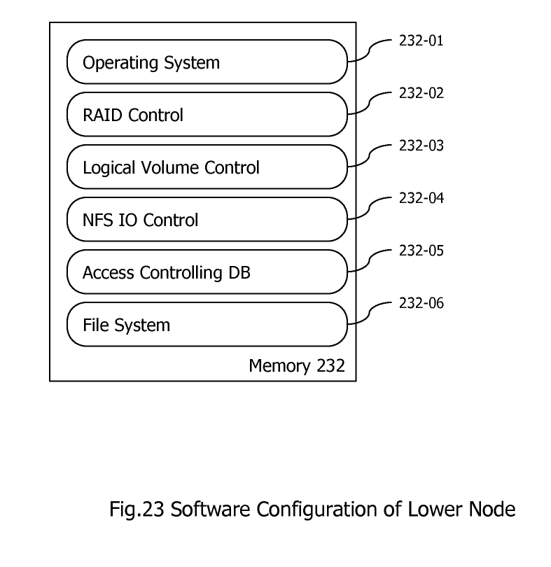

FIG. 23 shows the software configuration of lower node 230. The memory 232 of the lower node 230 has an operating system 232-01. A RAID control 232-02 creates RAID configuration by using storage devices behind the storage I/F 234. A logical volume control 232-03 processes SCSI layer read/write command, volume access control, and so on. An IO control 232-04 processes NFS as storage IO protocol. By using NFS, the lower node 230 allows the upper node(s) to connect (issue read/write IO) to the file system partition like ext3 (processed by File System 232-06) within the lower node 230. An access control DB 232-05 and a storage domain DB 232-06 store databases for NFS partition access controlling.

Dynamic Storage I/O Path Allocation

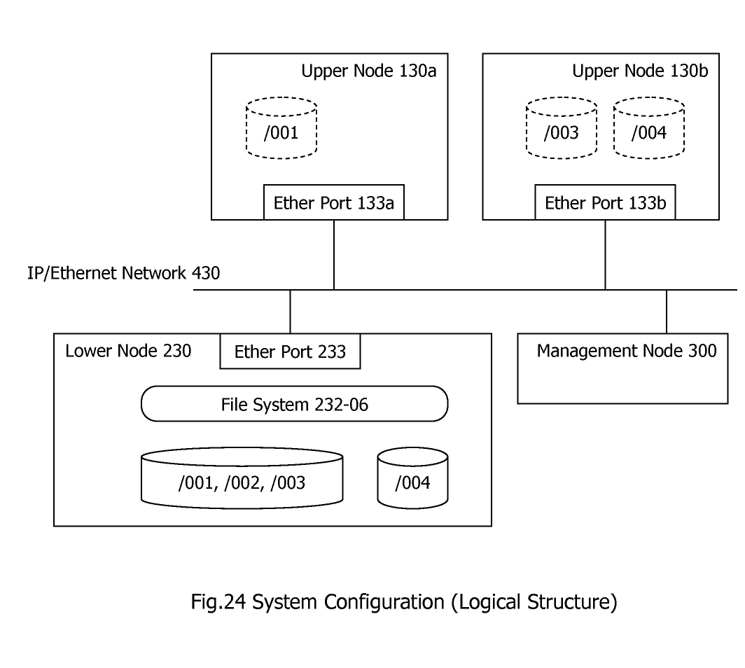

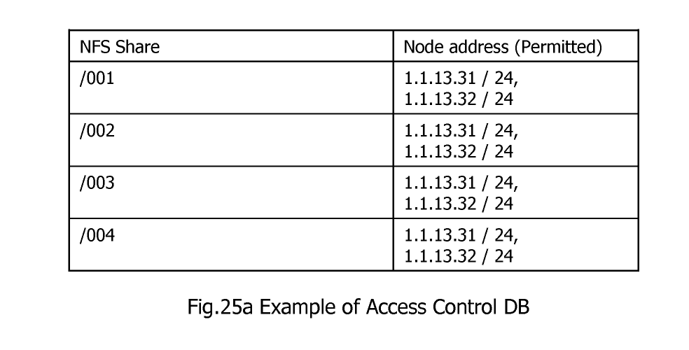

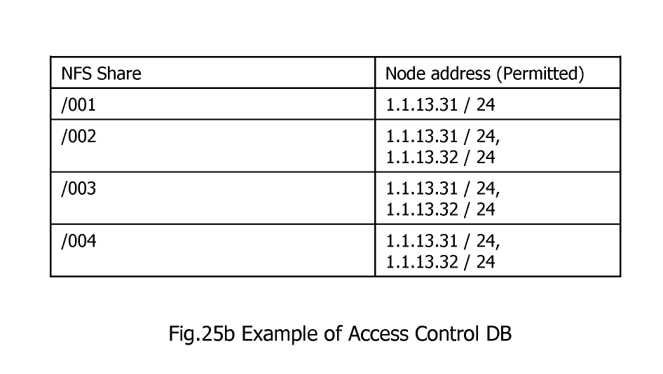

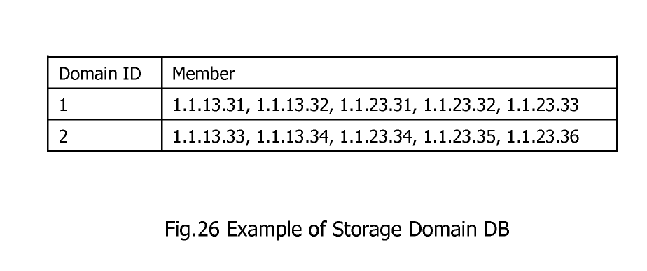

FIG. 24 shows an example of the logical structure of dynamic storage I/O path allocation for the information system of FIG. 21. The lower node 230 provides file system partitions (partitions 001-004) to the upper nodes 130a and 130b. At first, partitions 001-004 can be accessed from both upper nodes 130a and 130b because the lower node 230 and the upper nodes 130a and 130b join the same domain (see FIG. 26). In this case, the domain can be expressed by NFS access list table such as “hosts.allow.” The lower node 230 sets a first partition access control to allow the upper nodes 130a and 130b to discover partitions 001-004 (see FIG. 25a). Access control can be done by NFS access list table such as “hosts.allow” technologies.

Once the first upper node 130a tries to log in to partition 001, the lower storage node 230 allows the first upper storage node 130a to access partition 001. At the same time, the lower storage node 230 sets a second partition access control to allow only the first upper storage node 130a to access partition 001 (see FIG. 25b). Other storage nodes cannot discover and access partition 001 anymore even if they belong to the same domain. When the first upper storage node 130a logs out from partition 001, the lower storage node 230 disables the second partition access control for partition 001.

FIG. 25a shows an example of access control database for the first volume access control as discussed above. FIG. 25b shows an example of access control database for the second volume access control as discussed above. FIG. 26 shows an example of storage domain database illustrating nodes in domains as discussed above.

5. Multi-protocol

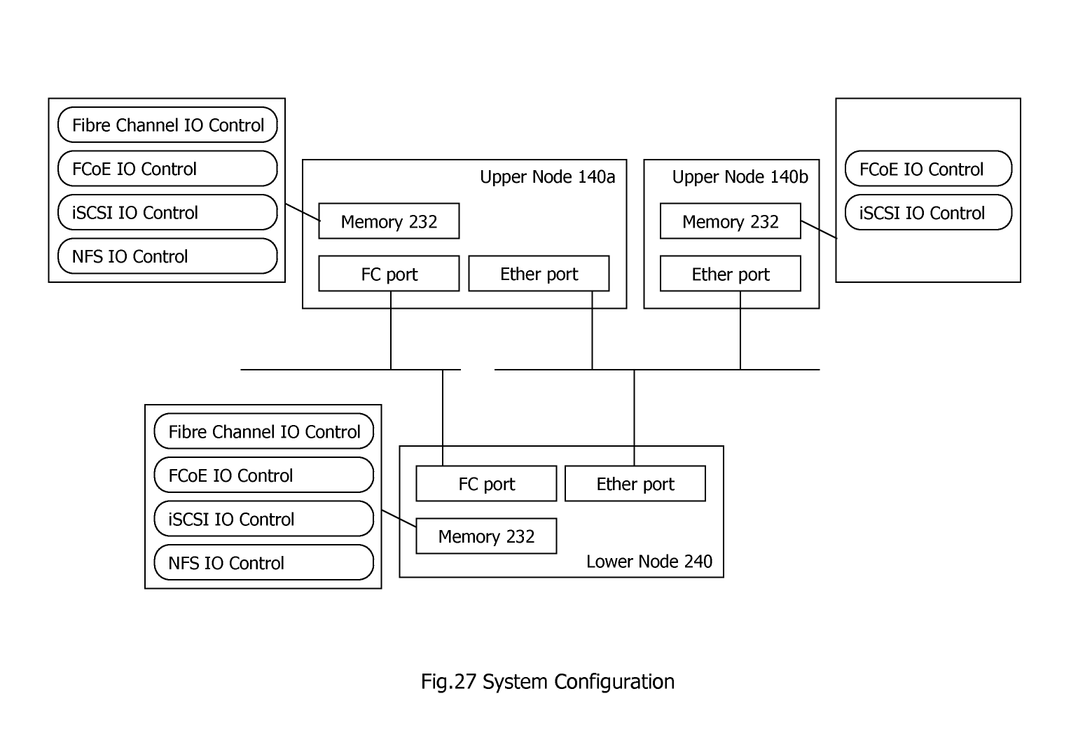

FIG. 27 illustrates an example of a hardware configuration of an information system for a multi-protocol environment. This invention will also work even if each node has a capability to handle one or more storage IO protocols. The information system has one or more upper nodes 140, a lower node 240, and a management node (not shown) connected via a network. The upper nodes 140 and lower node 240 each have a memory 232 including Fibre Channel IO control, FCoE IO control, iSCSI IO control, and NFS IO control.

Of course, the system configurations illustrated in FIGS. 1, 9, 15, 21, and 27 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for storage I/O path configuration and to reduce the workforce for configuring storage I/O path. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A method for storage I/O (input/output) path configuration in a system that includes a storage system connected via a network to a plurality of nodes, the method comprising:
receiving an I/O access to one or more storage volumes in the storage system from one of the nodes;
if the I/O access is an initial I/O access to any of the storage volumes in the storage system from any of the nodes in the system, allowing the initial I/O access from the one node and prohibiting I/O access to the storage volumes in the storage system by other nodes in the system; and
if the I/O access is not an initial I/O access to any of the storage volumes in the storage system from any of the nodes in the system, allowing the I/O access only if the I/O access is from the one node which made the initial I/O access and rejecting the I/O access for other nodes in the system.

2. The method according to claim 1, further comprising:
allowing the initial I/O access to the storage volumes in the storage system by a preset group of nodes in the system.

3. The method according to claim 2,
wherein the preset group of nodes is a subset of the plurality of nodes in the system, and other nodes in the system not in the preset group are not allowed the initial I/O access to the storage volumes in the storage system.

4. The method according to claim 2,
wherein access control by the preset group of nodes is achieved by any of LUN security/LUN masking, FC switch zoning, MAC address based access control, IP address based access control, TCP port addressed based access control, and iSNS database (iSCSI specific).

5. The method according to claim 2,
wherein receiving an I/O access comprises receiving a login request from one of the nodes in the system;
wherein the login request is allowed if the I/O access is an initial I/O access to any of the storage volumes in the storage system from any of the nodes in the system and if the one node making the login request is in the preset group of nodes; and
wherein the login request is rejected if the I/O access is not an initial I/O access to any of the storage volumes in the storage system from any of the nodes in the system or if the one node making the login request is not in the preset group of nodes.

6. The method according to claim 5, wherein the login request from the one node is allowed, and further comprising:
receiving by the storage system a logout request from the one node;
completing a logout process in response to the logout request from the one node;
formatting the storage volumes in the storage system; and
allowing a new initial I/O access to the formatted storage volumes in the storage system from a node that is in the preset group of nodes.

7. The method according to claim 6, further comprising:
creating one or more virtual ports in the storage system;
assigning a virtual port to each of the storage volumes in the storage system; and
activating the storage volumes and the one or more virtual ports;
wherein allowing a new initial I/O access comprises activating the formatted storage volumes and the one or more virtual ports.

8. A storage system in a system for storage I/O (input/output) path configuration which includes a plurality of nodes connected via a network to the storage system, the storage system comprising:
a processor;
a memory;
a plurality of storage volumes; and
an I/O control which is configured, in response to an I/O access to one or more storage volumes in the storage system from one of the nodes, to
if the I/O access is an initial I/O access to any of the storage volumes in the storage system from any of the nodes in the system, allow the initial I/O access from the one node and prohibiting I/O access to the storage volumes in the storage system by other nodes in the system; and
if the I/O access is not an initial I/O access to any of the storage volumes in the storage system from any of the nodes in the system, allow the I/O access only if the I/O access is from the one node which made the initial I/O access and rejecting the I/O access for other nodes in the system.

9. The storage system according to claim 8, wherein the I/O control is configured to allow the initial I/O access to the storage volumes in the storage system by a preset group of nodes in the system.

10. The storage system according to claim 9,
wherein the preset group of nodes is a subset of the plurality of nodes in the system, and other nodes in the system not in the preset group are not allowed the initial I/O access to the storage volumes in the storage system.

11. The storage system according to claim 9,
wherein the I/O access received by the storage system is a login request from one of the nodes in the system;
wherein the I/O control allows the login request if the I/O access is an initial I/O access to any of the storage volumes in the storage system from any of the nodes in the system and if the one node making the login request is in the preset group of nodes; and
wherein the I/O control rejects the login request if the I/O access is not an initial I/O access to any of the storage volumes in the storage system from any of the nodes in the system or if the one node making the login request is not in the preset group of nodes.

12. The storage system according to claim 11,
wherein the I/O control allows the login request and the storage system subsequently receives a logout request from the one node;
wherein the storage system includes a logical volume control;
wherein the I/O control is configured to complete a logout process in response to the logout request from the one node;
wherein the logical volume control is configured to format the storage volumes in the storage system after the logout process; and
wherein the I/O control is configured to allow a new initial I/O access to the formatted storage volumes in the storage system from a node that is in the preset group of nodes.

13. The storage system according to claim 12,
wherein the logical volume control is configured to create one or more virtual ports in the storage system and assign a virtual port to each of the storage volumes in the storage system, and the I/O control is configured to activate the storage volumes and the one or more virtual ports; and
wherein the I/O control is configured to allow a new initial I/O access by activating the formatted storage volumes and the one or more virtual ports.

14. The storage system according to claim 13,
wherein the I/O control is configured to process storage I/O protocol selected from the group consisting of FC (Fibre Channel), iSCSI (Internet Small Computer System Interface), FCoE (Fibre Channel over Ethernet), NFS (Network File System), and CIFS (Common Internet File System).

15. The storage system according to claim 14,
wherein the I/O control processes FC/FCoE storage I/O protocol; and
wherein the logical volume control creates the one or more virtual ports by NPIV (N_Port ID Virtualization).

16. The storage system according to claim 9,
wherein the nodes are storage systems.

17. A computer-readable storage medium storing a plurality of instructions for controlling a data processor to manage storage I/O (input/output) path configuration in a system that includes a storage system connected via a network to a plurality of nodes, the plurality of instructions comprising:
instructions that cause the data processor, if the I/O access is an initial I/O access to any of the storage volumes in the storage system from any of the nodes in the system, to allow the initial I/O access from the one node and prohibiting I/O access to the storage volumes in the storage system by other nodes in the system; and
instructions that cause the data processor, if the I/O access is not an initial I/O access to any of the storage volumes in the storage system from any of the nodes in the system, to allow the I/O access only if the I/O access is from the one node which made the initial I/O access and rejecting the I/O access for other nodes in the system.

18. The computer-readable storage medium according to claim 17, wherein the plurality of instructions further comprise:
instructions that cause the data processor to allow the initial I/O access to the storage volumes in the storage system by a preset group of nodes in the system, wherein the initial I/O access received by the storage system is a login request from one of the nodes in the system;
instructions that cause the data processor to allow the login request if the I/O access is an initial I/O access to any of the storage volumes in the storage system from any of the nodes in the system and if the one node making the login request is in the preset group of nodes; and
instructions that cause the data processor to reject the login request if the I/O access is not an initial I/O access to any of the storage volumes in the storage system from any of the nodes in the system or if the one node making the login request is not in the preset group of nodes.

19. The computer-readable storage medium according to claim 18, wherein the plurality of instructions further comprise:
instructions that cause the data processor, in response to a logout request from the one node that has I/O access, to complete a logout process of the one node;
instructions that cause the data processor to format the storage volumes in the storage system after the logout process; and
instructions that cause the data processor to allow a new initial I/O access to the formatted storage volumes in the storage system from a node that is in the preset group of nodes.

20. The computer-readable storage medium according to claim 19, wherein the plurality of instructions further comprise:
instructions that cause the data processor to create one or more virtual ports in the storage system and assign a virtual port to each of the storage volumes in the storage system, and to activate the storage volumes and the one or more virtual ports;
wherein the instructions to allow a new initial I/O access include instructions to activate the formatted storage volumes and the one or more virtual ports.
